(19) United States
(12) Patent Application Publication
(10) Pub. No.: US 2005/0273623 A1
(43) Pub. Date: Dec. 8, 2005

(54) Chip protection device and method

(75) Inventors: Chen-Chih Huang, Jhudong Township (TW); Ta-Hsun Yeh, Hsin-Chu City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Realtek Semiconductor Corp.

(21) Appl. No.: 11/131,048

(22) Filed: May 17, 2005

(30) Foreign Application Priority Data
May 21, 2004 (TW) 93114566

(51) Int. Cl. H04K 1/00

(52) U.S. Cl. 713/183

(57) ABSTRACT

A protection device disposed in a chip includes a decoding circuit for decoding a password and outputting a decoded signal, and a security circuit, coupled to the decoding circuit, for outputting an enable signal according to the decoded signal. The integrated circuit enables desired function of the chip according to the enable signal. Thus, the protection device can prevent the chip from being duplicated.

This application claims the benefit of Taiwan application Serial No. 93114566, filed May 21, 2004, the subject matter of which is incorporated herein by reference.

### BACKGROUND OF THE INVENTION

1. Field of the Invention

The invention relates in general to an integrated circuit, and more particularly to an integrated circuit protection device and a method therefor.

2. Description of the Related Art

An integrated circuit (IC) design company conventionally disposes one or a plurality of circuit breaking elements containing fuse(s) (e.g., poly fuse(s) or metal fuse(s)) in an integrated circuit (IC) to disabling a protected circuit from operation so as to protect the technology therein and prevent the circuit from being willfully duplicated. Because the circuit breaking element tends to be easily fused, the circuit breaking element can be fused by providing a high voltage or current through probes when the product is being tested, such that the protected circuit can operate normally. If the willful duplicator does not fuse the circuit breaking element, the protected circuit cannot operate normally.

The concept of using a fuse is to prevent the circuit from being duplicated in advance and then sold. However, the typical poly fuse or metal fuse needs extra probing pads, and the chip area and cost are thus increased. In addition, the appearance has the burn mark formed during the fusing operation, and the fused fuse tends to be easily sensed and cracked. So, the burn mark together with the probing pads having larger areas may become clues for the willful duplicator to realize how to crack the chip, and the protection capability is thus limited.

In order to successfully eliminate the limitation of the prior art circuit or method against the willful duplication, the invention provides a protection device and a protection method for preventing a chip from being duplicated, wherein a security circuit having a circuit breaking element is added to the integrated circuit (IC) during the design phase, and the desired property of the IC cannot be enabled until a default and unique password is inputted and successfully decrypted by a decoding circuit.

### SUMMARY OF THE INVENTION

It is therefore one of objectives of the invention to provide a chip protection device for protecting a chip and a method therefor.

It is therefore one of objectives of the invention is to provide a chip protection device for enabling desired functions of a chip only when a password that can be decoded is successfully decrypted, and a method therefor.

The invention achieves the above-identified objectives by providing a protection device for outputting an enable signal to enable a protected circuit, the protection device comprises: a decoding circuit to receive a password and decode the password to output a decoded signal; and a security circuit, coupled to the decoding circuit, to output the enable signal according to the decoded signal.

The invention also achieves the above-identified objectives by providing a decrypting method being used in a chip. The method includes the steps of: receiving a password; comparing the password with a predetermined value; and changing an electric property of a security circuit when the password matches with the predetermined value.

The invention also achieves the above-identified objectives by providing a method for enabling a protected circuit of a chip. The method comprises: receiving a password; decoding the password to generating an enable signal; and enabling the protected circuit of the chip according to the enable signal.

The invention also achieves the above-identified objectives by providing an integrated circuit (IC) comprising: a protected circuit to execute a function of IC according to an enable signal; and a protection circuit, coupled to the protected circuit, to receive a N-bit password and output the enable signal when the password matches with a predetermined value.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a schematic illustration showing a protection device according to an embodiment of the invention.

FIG. 2 is a flow chart showing steps of a decrypting method of the invention.

FIG. 3 is a more detailed schematic illustration showing the protection device of the invention.

### DETAILED DESCRIPTION OF THE INVENTION

In order to prevent the willful duplicator from duplicating the integrated circuit (IC), the invention provides a protection device and a protection method for preventing a chip from being duplicated, wherein a security circuit having a circuit breaking element is added to the integrated circuit (IC) during the design phase, and the desired property of the IC cannot be enabled until a default password is inputted and successfully decrypted by a decoding circuit.

FIG. 1 is a schematic illustration showing a protection device according to an embodiment of the invention. Referring to FIG. 1, the invention discloses an integrated circuit, which includes a protected circuit 15 and a protection circuit 12. The protected circuit 15 determines whether or not the desired property is to be enabled for the purpose of a normal operation according to an enable signal. The protection circuit 12 coupled to the protected circuit 15 includes a decoding circuit 11 and a security circuit 13. The decoding circuit 11 receives a password, compares the password with a default password, and then outputs a decoded signal according to the result of the comparison. In an embodiment, the decoding circuit comprises at least one comparator. The security circuit 13 receives the decoded signal, changes the electric property of the security circuit 13 according to the decoded signal (i.e., when the password matches with the default password), and outputs the corresponding enable signal.

In one embodiment, the decoding circuit 11 and the protected circuit 15 are composed of a plurality of logic elements. So, the duplicator cannot know that each of the logic elements belongs to the decoding circuit 11 or the protected circuit 15. In one embodiment, the password received by the decoding circuit 11 comes from a portion of memories of the IC or from at least one input port of the IC. So, the duplicator also cannot know the correct password has to be inputted to which registers or which Flip-Flops or which input port. The memory may be implemented by way of registers, flip-flops, or other storage elements.

In another embodiment, one or a plurality of protection circuits 12 may be disposed in the integrated circuit, and the position or and number of the protection circuits 12 is not limited.

As shown in the drawing, a default and unique password is inputted to the decoding circuit 11 during the testing process, and the decoding circuit 11 makes the comparison. If the password comparison does not success, the electric property of the security circuit 13 cannot be changed. If the comparison successes, a decoded signal is transferred to the security circuit 13 to change the electric property of the security circuit 13. For example, a high voltage or current can be supplied to fuse the circuit breaking element of the security circuit 13 such that the desired function of the protected circuit 15 is enabled.

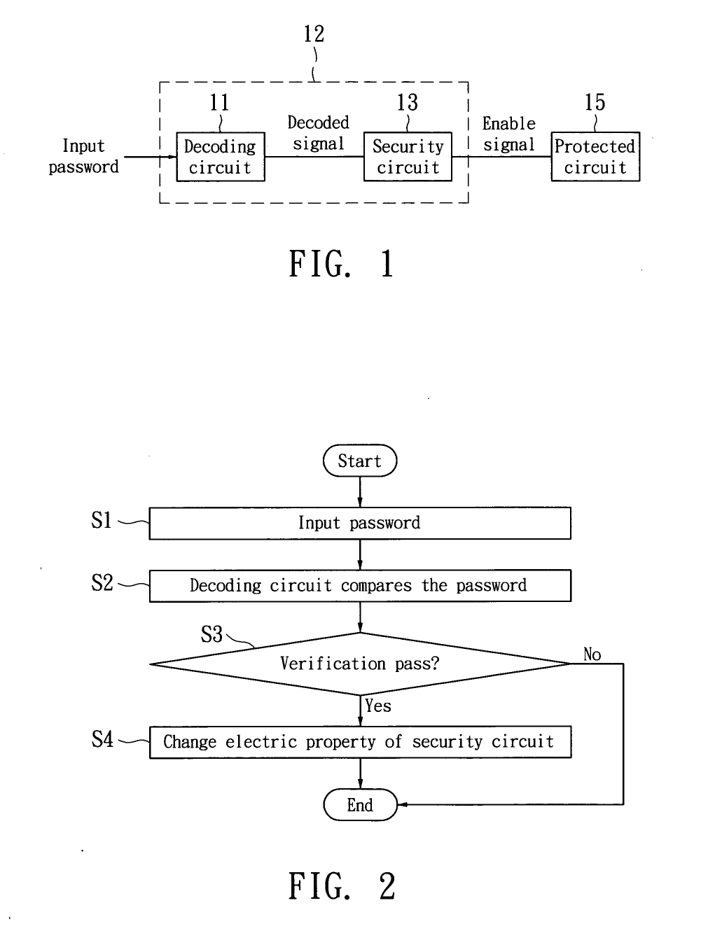

FIG. 2 is a flow chart showing steps of a decrypting method of the invention.

In this embodiment, when the IC is tested, a decrypting step is performed. The default value of the decoded signal of the decoding circuit 11 is “high”, so a switching 35 of the security circuit 13 turns off, the enable signal of the security circuit 13 is “Low” and the protected circuit 15 is disabled.

In step S1, a password (N bit password) is inputted to a decoding circuit 11. In an embodiment, the password is predetermined when the integrated circuit (IC) is designed, and may be composed of a plurality of bit signal logic circuits. The security level can be changed by changing the length of the bit signal.

In step S2, the decoding circuit 11 compares the inputted password to the designed password that is predetermined.

In step S3, it is judged whether or not the inputted password matches with the designed password in the decoding circuit. If the verification does not pass (i.e., the inputted password does not match with the designed password), the decoded signal of the decoding circuit is still in the default state, and the security circuit 13 still cannot change its electric property. That is, the default value of the decoded signal makes the switch 35 of the security circuit 13 off, so the protected circuit 15 is disabled.

In step S4, once the verification passes (i.e., the inputted password matches with the designed password), the electric property of the security circuit 13 is changed so that a protected circuit 15 is enabled. The embodiment may be made by fusing the circuit breaking element 31 so as to enable the protected circuit 15 by changing the electric property of the security circuit 13. In this embodiment, after the verification passes, the output of the decoding circuit is “low”. At this time, the switch (PMOS transistor) 35 turns on, and a great current flows through the PMOS 35 and fuses the circuit breaking element (fuse) 31. Thus, the enable signal is “high”, and the protected circuit 15 is enabled. Consequently, when the willful third one gets the whole circuit and duplicates the same circuit, he or she does not know the password or where the password has to be inputted. Hence, the circuit cannot be normally enabled because the verification does not pass.

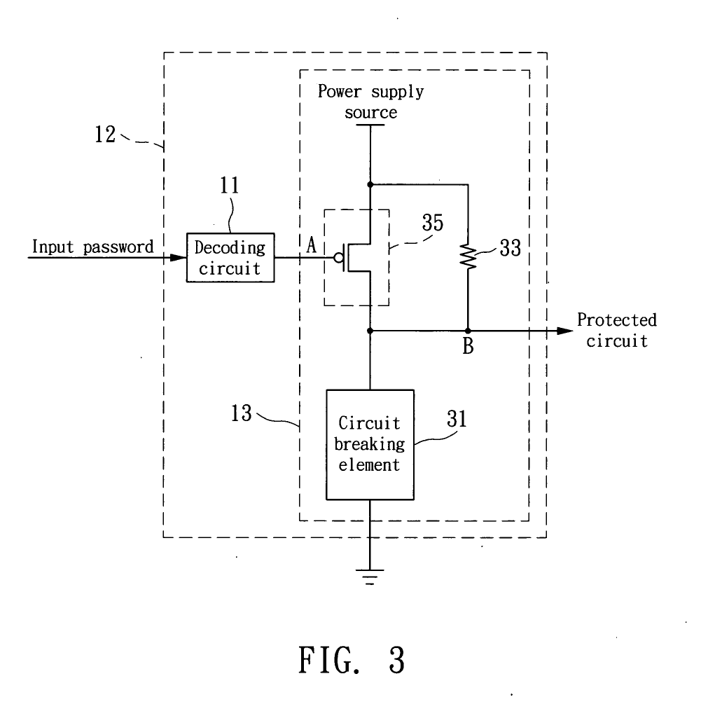

FIG. 3 is a detailed schematic illustration of an embodiment of the protection device 12 of the invention. In this embodiment, the device 12 includes a decoding circuit 11, from which the password can be inputted. The decoding circuit 11 is coupled to one end of the switch 35 of the security circuit 13 and controls the on/off state of the switch 35. The switch 35 may be a transistor, such as the CMOS, PMOS or NMOS transistor. Another end of the switch 35 is coupled to a power supply source, and also coupled to a resistor 33. The switch 35 is further coupled to a circuit breaking element 31, which may be a fuse. In an embodiment, the resistor 33 can be omitted.

Because the circuit breaking element 31 is grounded and has a small resistance as compared to that of the resistor 33 and the switch 35 is off, the enable signal is “low” (point B). The protected circuit 15 is configured such that it is disabled when the enable signal is low. Meanwhile, the default value of the decoded signal of the decoding circuit 11 is high (point A), so the switch 35 is off.

Please refer to FIG. 2 and FIG. 3. First, a password is inputted to the decoding circuit 11. Then, the decoded signal of the decoding circuit 11 is low (point A) after the verification passes. At this time, the switch 35 turns on, and a current flows through the switch 35 to fuse the circuit breaking element 31 and thus break the circuit breaking element 31. Thus, the enable signal is high (point B). The protected circuit is configured such that it is enabled when the enable signal is high.

In another embodiment, one end of the resistor 33 and one end of the switch 35 are grounded, and one end of the circuit breaking element 31 is coupled to the power supply source. The protected circuit 15 is configured such that it is enabled when the enable signal is low.

While the invention has been described by way of examples and in terms of preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. A protection device for outputting an enable signal to enable a protected circuit, the device comprising:
a decoding circuit to receive a password and decode the password to output a decoded signal; and
a security circuit, coupled to the decoding circuit, to output the enable signal according to the decoded signal.

2. The device according to claim 1, wherein the security circuit comprises:
a circuit breaking element, to change an electric property of the security circuit according to the decoded signal such that the protected circuit is enabled.

3. The device of claim 2, wherein the circuit breaking element comprises a fuse.

4. The device of claim 2, wherein the electric property of the security circuit is changed by fusing the circuit breaking element.

5. The device of claim 2, wherein the switch is a transistor.

6. The device of claim 1, wherein the decoding circuit comprises a plurality of logic units.

7. The device of claim 1, wherein the decoding circuit comprises at least one of comparators.

8. The device of claim 1, wherein the password comes from at least one storage unit of a plurality of storage units.

9. The device of claim 1, wherein the password is inputted from at least one input port.

10. A decrypting method being used in a chip, comprising:
receiving a password;
comparing the password with a predetermined value; and
changing an electric property of a security circuit when the password matches with the predetermined value.

11. The method of claim 10, wherein the password comes from at least one storage unit or from at least one input port.

12. The method of claim 10, wherein the step of changing the electric property of the security circuit comprises: fusing a circuit-breaking element of the security circuit.

13. A method for enabling a protected circuit of a chip, comprising:
receiving a password;
decoding the password to generate an enable signal; and
enabling the protected circuit of the chip according to the enable signal.

14. The method of claim 13, wherein the step of decoding comprises:
decoding the password to output a decoded signal; and
changing a level of the enable signal according to the decoded signal.

15. The method of claim 13, wherein the step of decoding comprises:
comparing the password with a predetermined value to generate the decoded signal.

16. An integrated circuit (IC), comprising:
a protected circuit to execute a function of IC according to an enable signal; and
a protection circuit, coupled to the protected circuit, to receive a N-bit password and output the enable signal when the N-bit password matches with a predetermined value.

17. The IC of claim 16, wherein the protection circuit comprises:
a first circuit to decode the password and output a control signal; and
a second circuit, coupled to the first circuit, to output the enable signal according to the control signal.

18. The IC of claim 17, wherein the second circuit comprises:
a circuit breaking element, to change an electric property of the second circuit according to the control signal.

19. The IC of claim 18, wherein the second circuit changes the enable signal by fusing the circuit breaking element.

20. The IC of claim 16, wherein the IC further comprises a plurality of pins and the password comes from at least one of the pins.

21. The IC of claim 16, wherein the password is a multi-bit password.

22. The IC of claim 16, wherein the protection circuit comprises: a decoder to decode the password to output the enable signal.
